(19) United States
(12) Patent Application Publication
(10) Pub. No.: US 2024/0257562 A1
(43) Pub. Date: Aug. 1, 2024

(54) PALM IMAGE RECOGNITION METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Yafei YUAN, Shenzhen (CN); Wen GE, Shenzhen (CN); Lulu JIAO, Shenzhen (CN); Jiayu HUANG, Shenzhen (CN); Runzeng GUO, Shenzhen (CN); Ruixin ZHANG, Shenzhen (CN); Yingyi ZHANG, Shenzhen (CN); Hang ZHOU, Shenzhen (CN); Jun WANG, Shenzhen (CN)

(21) Appl. No.: 18/626,162

(22) Filed: Apr. 3, 2024

Related U.S. Application Data
(63) Continuation of application No. PCT/CN2023/091970, filed on May 4, 2023.

(30) Foreign Application Priority Data
Jul. 18, 2022 (CN) 202210840618.3

(51) Int. Cl. G06V 40/60; G06T 7/11; G06T 7/62; G06T 7/70; G06V 10/25; G06V 10/74; G06V 40/12

(52) U.S. Cl. CPC G06V 40/67; G06T 7/11; G06T 7/62; G06T 7/70; G06V 10/25; G06V 10/761; G06V 40/1347; G06V 2201/07

(57) ABSTRACT

This application discloses a palm image recognition method performed by a computer device. The method includes: performing palm detection on a palm image captured by a camera to generate a palm box for a palm in the palm image (304); determining location information of the palm relative to the camera based on the palm box and the palm image; and displaying a palm identifier corresponding to the palm based on the location information, the palm identifier being used for indicating the palm to move to a preset spatial location corresponding to the camera to obtain an object identifier corresponding to the palm image. A user, based on the palm identifier, moves its palm to the preset spatial location corresponding to the camera to perform palm image recognition.

### CROSS-REFERENCE TO RELATED APPLICATIONS

This application is a continuation application of PCT Patent Application No. PCT/CN2023/091970, entitled “PALM IMAGE RECOGNITION METHOD AND APPARATUS, DEVICE, STORAGE MEDIUM, AND PROGRAM PRODUCT” filed on May 4, 2023, which claims priority to Chinese Patent Application No. 202210840618.3, entitled “PALM IMAGE RECOGNITION METHOD AND APPARATUS, DEVICE, STORAGE MEDIUM, AND PROGRAM PRODUCT” filed on Jul. 18, 2022, all of which is incorporated by reference in its entirety.

This application relates to U.S. patent application Ser. No. ______, entitled “GUIDING METHOD AND APPARATUS FOR PALM VERIFICATION, TERMINAL, STORAGE MEDIUM, AND PROGRAM PRODUCT” filed on ______, (Attorney Docket No. 031384-8021-US), which is incorporated herein by reference in its entirety.

This application relates to U.S. patent application Ser. No. 18/431,821, entitled “IMAGE ACQUISITION METHOD AND APPARATUS, COMPUTER DEVICE, AND STORAGE MEDIUM” filed on Feb. 2, 2024, which is incorporated herein by reference in its entirety.

### FIELD OF THE TECHNOLOGY

Embodiments of this application relate to the field of computer technologies, and in particular, to a palm image recognition method and apparatus, a device, a storage medium, and a program product.

### BACKGROUND OF THE DISCLOSURE

With development of computer technologies, a palm recognition technology is increasingly widely applied, and may be applied in a plurality of scenarios. For example, in a payment scenario or a clock-in scenario, an identity of a user may be verified through palm recognition.

In the related art, when a user swipes a palm, a computer device captures a palm image, and the computer device transmits the palm image to a palm recognition server through a network. The palm recognition server recognizes the palm image to complete identity recognition.

How to ensure that a user quickly adjusts a palm to an appropriate palm swipe location when the user faces a palm image recognition device with a camera and swipes the palm is an important problem that urgently needs to be resolved.

### SUMMARY

This application provides a palm image recognition method and apparatus, a device, a storage medium, and a program product. The technical solutions are as follows:

According to an aspect of this application, a palm image recognition method is performed by a computer device, and the method including:
performing palm detection on a palm image captured by a camera to generate a palm box for a palm in the palm image;
determining location information of the palm relative to the camera based on the palm box and the palm image; and
displaying a palm identifier corresponding to the palm on a screen based on the location information, the palm identifier being used for indicating the palm to move to a preset spatial location corresponding to the camera to obtain an object identifier corresponding to the palm image.

According to an aspect of this application, a palm identifier display method is provided, the method being performed by a computer device, and the method including:
displaying an interaction interface of a palm image recognition device;
displaying a palm identifier corresponding to a palm image and an effective recognition region identifier in response to a palm image recognition operation triggered on the palm image recognition device, the palm identifier being used for representing a spatial location of a palm relative to the palm image recognition device, and the effective recognition region identifier being used for indicating a preset spatial location corresponding to a camera;
updating a display location of the palm identifier on the interaction interface in response to movement of the palm, the display location corresponding to a location of the palm in front of the camera; and
in response to that the palm identifier moves to a location of the effective recognition region identifier, displaying first prompt information indicating that the palm image is undergoing palm image recognition.

According to another aspect of this application, a computer device is provided, the computer device including a processor and a memory, the memory storing at least one computer program, and the at least one computer program being loaded and executed by the processor and causing the computer device to implement the palm image recognition method according to the foregoing aspects.

According to another aspect of this application, a non-transitory computer-readable storage medium is provided, the computer-readable storage medium storing at least one computer program, and the at least one computer program being loaded and executed by a processor of a computer device and causing the computer device to implement the palm image recognition method according to the foregoing aspects.

The technical solutions provided in this application have at least the following beneficial effect:

A palm image is obtained by using a camera; palm detection is performed on the palm image to generate a palm box for a palm in the palm image; location information of the palm relative to a palm image recognition device is determined based on the palm box and the palm image; and a palm identifier corresponding to the palm on a screen is displayed based on the location information, the palm identifier being used for indicating the palm to move to a preset spatial location corresponding to the camera, to perform recognition on a palm image captured by the camera at the preset spatial location to obtain an object identifier corresponding to the palm image. In this application, the location information of the palm relative to the camera is determined based on the palm image and the palm box in the palm image, and the palm identifier corresponding to the palm is displayed on the screen based on the location information. An object can be helped, based on the palm identifier, to move the palm to the preset spatial location corresponding to the camera. In this way, the object is guided to quickly move the palm to an appropriate palm swipe location. This improves recognition efficiency of palm image recognition.

### BRIEF DESCRIPTION OF THE DRAWINGS

FIG. 1 is a schematic diagram of a palm image recognition method according to an exemplary embodiment of this application.

FIG. 2 is a schematic architectural diagram of a computer system according to an exemplary embodiment of this application.

FIG. 3 is a flowchart of a palm image recognition method according to an exemplary embodiment of this application.

FIG. 4 is a flowchart of a palm image recognition method according to an exemplary embodiment of this application.

FIG. 5 is a schematic diagram of a palm box on a palm according to an exemplary embodiment of this application.

FIG. 6 is a schematic diagram of a finger seam point on a palm according to an exemplary embodiment of this application.

FIG. 7 is a schematic diagram of a palm box on a palm according to an exemplary embodiment of this application.

FIG. 8 is a schematic diagram of cross-device payment based on a palm image recognition method according to an exemplary embodiment of this application.

FIG. 9 is a schematic diagram of cross-device identity verification based on a palm image recognition method according to an exemplary embodiment of this application.

FIG. 10 is a flowchart of a palm identifier display method according to an exemplary embodiment of this application.

FIG. 11 is a flowchart of a palm identifier display method according to an exemplary embodiment of this application.

FIG. 12 is a schematic diagram of an interaction interface of a palm image recognition device according to an exemplary embodiment of this application.

FIG. 13 is a schematic diagram of location information of a palm relative to a palm image recognition device according to an exemplary embodiment of this application.

FIG. 14 is a schematic diagram of a palm identifier relative to an effective recognition region identifier according to an exemplary embodiment of this application.

FIG. 15 is a schematic diagram of an interaction interface on which palm image recognition is in progress according to an exemplary embodiment of this application.

FIG. 16 is a flowchart of a palm image recognition method according to an exemplary embodiment of this application.

FIG. 17 is a block diagram of a palm image recognition apparatus according to an exemplary embodiment of this application.

FIG. 18 is a block diagram of a palm identifier display apparatus according to an exemplary embodiment of this application.

FIG. 19 is a schematic structural diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

First, several terms included in the embodiments of this application are briefly described:

Artificial intelligence (AI) involves a theory, a method, a technology, and an application system that use a digital computer or a machine controlled by a digital computer to simulate, extend, and expand human intelligence, perceive an environment, obtain knowledge, and use the knowledge to obtain an optimal result. In other words, AI is a comprehensive technology in computer science and attempts to understand the essence of intelligence and produce a new intelligent machine that can react in a manner similar to human intelligence. AI is to study design principles and implementation methods of various intelligent machines, to enable the machines to have functions of perception, reasoning, and decision-making.

The AI technology is a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

A cloud technology is a hosting technology that integrates a series of resources such as hardware, software, and network resources in a wide area network or a local area network to implement data computing, storage, processing, and sharing.

The cloud technology is a general term for a network technology, an information technology, an integration technology, a management platform technology, an application technology, and the like that are based on application of a cloud computing business model, and may constitute a resource pool for use on demand and therefore is flexible and convenient. A cloud computing technology is to become an important support. A background service of a technology network system requires a large number of computing and storage resources, such as video websites, picture websites, and more portal websites. With advanced development and application of the Internet industry, in the future, each object may have its own identifier, and needs to be transmitted to a background system for logical processing. Data at different levels is to be processed separately. All types of industry data require a strong system support, which can be implemented only through cloud computing.

Cloud computing is a computing model that distributes computing tasks to a resource pool including a large number of computers, so that various application systems can obtain computing power, storage space, and information services according to requirements. A network that provides resources is referred to as a “cloud”. Resources in the “cloud” seem infinitely scalable to a user, and may be obtained at any time, used on demand, expanded at any time, and paid per use.

As a basic capability provider for cloud computing, a cloud computing resource pool (cloud platform for short, usually referred to as an infrastructure as a service (IaaS) platform) is established, and a plurality of types of virtual resources are deployed in the resource pool for external customers to choose to use. The cloud computing resource pool mainly includes a computing device (a virtual machine including an operating system), a storage device, and a network device.

Through division based on logical functions, a platform as a service (PaaS) layer may be deployed above an IaaS layer, and then a software as a service (SaaS) layer is deployed above the PaaS layer, or the SaaS may be directly deployed above the IaaS. The PaaS is a software running platform, for example, a database or a World Wide Web (Web) container. The SaaS is a variety of service software, for example, a web portal or a group SMS message transmitter. Generally, the SaaS and the PaaS are upper layers relative to the IaaS.

The CV technology is a science that studies how to use a machine to “see”, and furthermore, that uses a camera and a computer to replace human eyes to perform machine vision such as recognition and measurement on a target, and further perform graphics processing, so that the computer processes the target into an image more suitable for human eyes to observe, or an image transmitted to an instrument for detection. As a scientific discipline, the CV studies related theories and technologies and attempts to establish an AI system that can obtain information from images or multidimensional data. The CV technology usually includes image processing, image recognition, image semantic comprehension, image retrieval, video processing, video semantic comprehension, video content/behavior recognition, three-dimensional (3D) object reconstruction, a 3D technology, virtual reality, augmented reality, simultaneous localization and mapping, and the like, and further includes common biometric feature recognition technologies.

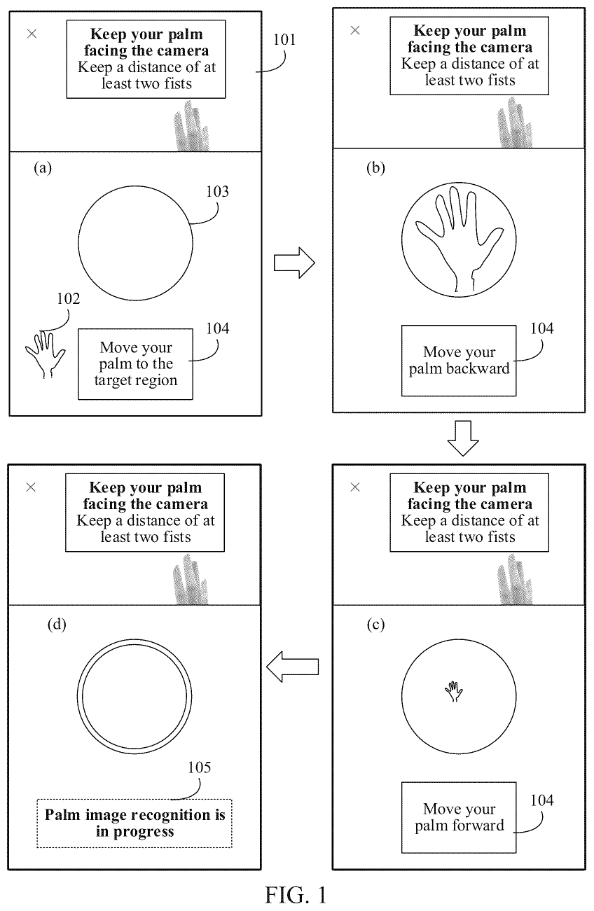

The embodiments of this application provide a schematic diagram of a palm image recognition method. As shown in FIG. 1, the method is applied to a palm image recognition device with a camera. The method may be performed by a computer device. The computer device may be a terminal or a server.

For example, the computer device displays an interaction interface 101 of the palm image recognition device; the computer device displays a palm identifier 102 corresponding to a palm image and an effective recognition region identifier 103 in response to a palm image recognition operation triggered on the palm image recognition device; the computer device updates a display location of the palm identifier 102 on the interaction interface 101 in response to movement of a palm, the display location corresponding to a location of the palm in front of the camera; and in response to that the palm identifier 102 moves to a location of the effective recognition region identifier 103, the computer device displays first prompt information 105 indicating that the palm image is undergoing palm image recognition.

In some embodiments, in response to that the palm identifier 102 moves to the location of the effective recognition region identifier 103, the computer device displays the first prompt information 105 indicating that the palm image is undergoing palm image recognition, and cancels the display of the palm identifier 102.

The palm identifier 102 is used for representing a spatial location of the palm relative to the palm image recognition device, to be specific, a corresponding identifier displayed for the palm on the interaction interface 101 during capturing of the palm image by the camera. The palm identifier 102 moves along with the palm.

The effective recognition region identifier 103 is used for indicating a preset spatial location corresponding to the camera. When the palm moves to the preset spatial location, the palm image captured by the camera has optimal quality, and the palm image can be quickly recognized.

For example, the computer device displays the location information of the palm relative to the camera during capturing of the palm image by the camera in response to the palm image recognition operation triggered on the palm image recognition device.

In some embodiments, the computer device displays relative location information between the palm identifier 102 and the effective recognition region identifier 103 to represent orientation information between the palm and the camera in response to the palm image recognition operation triggered on the palm image recognition device. For example, as shown in a diagram (a) in FIG. 1, the computer device displays the orientation information of the palm relative to the camera on the interaction interface 101 by using the location information of the palm identifier 102 relative to the effective recognition region identifier 103. On the interaction interface 101, the palm identifier 102 is located in the lower left of the effective recognition region identifier 103. In this case, it can be learned that the palm is also located in the lower left of the camera. When the palm identifier 102 is not at a location of the effective recognition region identifier 103, second prompt information 104 “Move your palm to the target region” is displayed on the interaction interface 101.

The second prompt information 104 is used for indicating the palm identifier 102 to move to the location of the effective recognition region identifier 103.

In some embodiments, the computer device displays a shape change of the palm identifier 102 to represent distance information between the palm and the camera in response to the palm image recognition operation triggered on the palm image recognition device.

The distance information is a distance between the palm and the camera.

For example, as shown in a diagram (b) in FIG. 1, the computer device displays the distance information between the palm and the camera by using the shape change of the palm identifier 102 on the interaction interface 101. When the palm identifier 102 is at the location of the effective recognition region identifier 103 on the interaction interface 101 and the palm is close to the camera, the computer device indicates the distance between the palm and the camera by enlarging a shape of the palm identifier 102 on the interaction interface 101, and displays second prompt information 104 “Move your palm backward” on the interaction interface 101.

For example, as shown in a diagram (c) in FIG. 1, when the palm identifier 102 is at the location of the effective recognition region identifier 103 on the interaction interface 101 and the palm is far away from the camera, the computer device indicates the distance between the palm and the camera by narrowing a shape of the palm identifier 102 on the interaction interface 101, and displays second prompt information 104 “Move your palm forward” on the interaction interface 101.

In some embodiments, the shape of the palm identifier 102 becomes larger when the palm is close to the camera, and the shape of the palm identifier 102 becomes smaller when the palm is far away from the camera. However, this does not constitute a limitation. This is not specifically limited in the embodiments of this application.

For example, in response to that the palm identifier 102 moves to the location of the effective recognition region identifier 103, the computer device displays the first prompt information 105 indicating that the palm image is undergoing palm image recognition.

For example, as shown in a diagram (d) in FIG. 1, when the palm identifier 102 moves to the effective recognition region identifier 103 and the palm image is recognizable, the first prompt information 105 “Palm image recognition is in progress” indicating that the palm image is undergoing palm image recognition is displayed.

To sum up, in the method provided in this embodiment, the interaction interface of the palm image recognition device is displayed; the palm identifier corresponding to the palm image and the effective recognition region identifier are displayed in response to the palm image recognition operation triggered on the palm image recognition device; the display location of the palm identifier on the interaction interface is updated in response to movement of the palm, the display location corresponding to the location of the palm in front of the camera; and in response to that the palm identifier moves to the location of the effective recognition region identifier, the first prompt information indicating that the palm image is undergoing palm image recognition is displayed. In this application, the palm corresponding to an object is displayed as the palm identifier on the interface, the preset spatial location corresponding to the camera is displayed as the effective recognition region identifier on the interaction interface, and the relative location information between the palm identifier and the effective recognition region identifier is displayed on the interaction interface to represent the orientation information and the distance information between the palm and the camera, to guide the object to quickly move the palm to an appropriate palm swipe location. This improves recognition efficiency of palm image recognition.

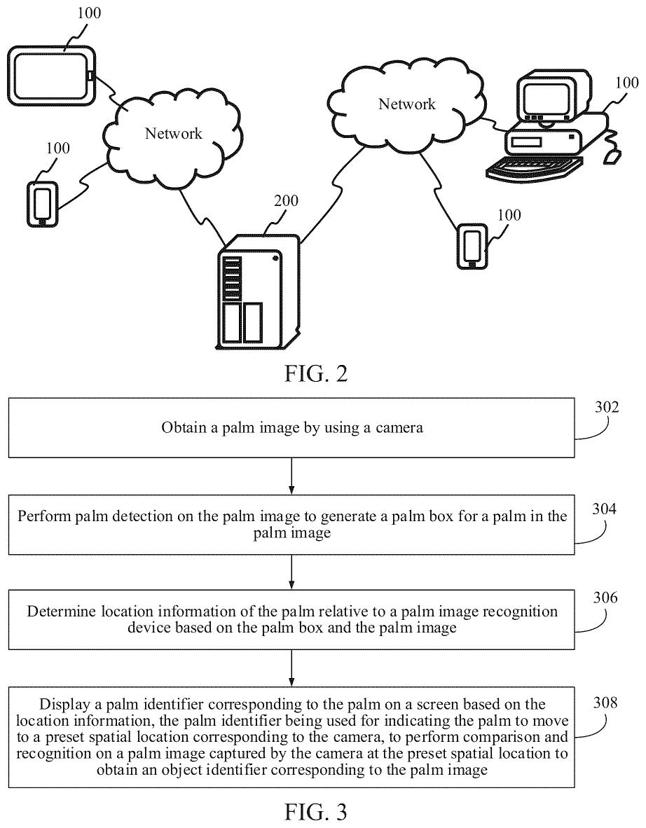

FIG. 2 is a schematic architectural diagram of a computer system according to an embodiment of this application. The computer system may include a terminal 100 and a server 200.

The terminal 100 may be an electronic device such as a mobile phone, a tablet computer, a vehicle-mounted terminal (in-vehicle infotainment system), a wearable device, a personal computer (PC), a smart voice interaction device, a smart home appliance, an aircraft, or a self-service sales terminal. A client for a target application may be installed and run on the terminal 100. The target application may be an application with reference to palm image recognition, or may be another application providing a palm image recognition function. This is not limited in this application. In addition, a form of the target application is not limited in this application. The target application includes but is not limited to an application (app) installed on the terminal 100, a mini program, and the like, or may be in a form of a web page.

The server 200 may be an independent physical server, or may be a server cluster or a distributed system that includes a plurality of physical servers, or may be a cloud server that provides basic cloud computing services, for example, a cloud server that provides a cloud computing service, a cloud database, cloud computing, a cloud function, cloud storage, a network service, cloud communication, a middleware service, a domain name service, a security service, a content delivery network (CDN), big data, and an AI platform. The server 200 may be a background server for the target application and is configured to provide a background service for the client of the target application.

A cloud technology is a hosting technology that integrates a series of resources such as hardware, software, and network resources in a wide area network or a local area network to implement data computing, storage, processing, and sharing. The cloud technology is a general term for a network technology, an information technology, an integration technology, a management platform technology, an application technology, and the like that are based on application of a cloud computing business model, and may constitute a resource pool for use on demand and therefore is flexible and convenient. A cloud computing technology is to become an important support. A background service of a technology network system requires a large number of computing and storage resources, such as video websites, picture websites, and more portal websites. With advanced development and application of the Internet industry, in the future, each object may have its own identifier, and needs to be transmitted to a background system for logical processing. Data at different levels is to be processed separately. All types of industry data require a strong system support, which can be implemented only through cloud computing.

In some embodiments, the server may alternatively be implemented as a node in a blockchain system. A blockchain is a new application model for computer technologies such as distributed data storage, peer-to-peer transmission, a consensus mechanism, and an encryption algorithm. The blockchain is essentially a decentralized database, and is a series of data blocks generated through association by using a cryptographic method. Each data block includes information of a batch of network transactions, to verify validity of the information (anti-counterfeiting) and generate a next block. The blockchain may include a blockchain underlying platform, a platform product service layer, and an application service layer.

The terminal 100 and the server 200 may communicate with each other through a network, for example, a wired or wireless network.

In the palm image recognition method provided in the embodiments of this application, steps may be performed by a computer device. The computer device is an electronic device with data computing, processing, and storage capabilities. The solution implementation environment shown in FIG. 2 is used as an example. The palm image recognition method may be performed by the terminal 100 (for example, the palm image recognition method is performed by the client for the target application that is installed and run on the terminal 100), or the palm image recognition method may be performed by the server 200, or performed by the terminal 100 and the server 200 through interaction and cooperation. This is not limited in this application.

FIG. 3 is a flowchart of a palm image recognition method according to an exemplary embodiment of this application. The method is applied to a palm image recognition device with a camera and a large screen. The method may be performed by a computer device. The computer device may be the terminal 100 or the server 200 in FIG. 2. The method includes the following steps:

Step 302: Obtain a palm image by using the camera.

The palm image is a palm image of a to-be-determined object identifier. The palm image includes a palm. The palm is a palm of an object whose identity is to be verified. The palm image may further include other information, for example, a finger of the object or a scene in which the camera photographs the palm of the object.

For example, the palm image may be obtained by the camera in the computer device by photographing the palm of the object whose identity is to be verified, or may be captured and transmitted by a camera carried in another device.

For example, the computer device is a payment device in a store, and the payment device in the store photographs a palm of an object by using a camera to obtain a palm image. Alternatively, the computer device is a palm image recognition server, and a payment device in a store captures a palm image of an object by using a camera and then transmits the palm image to the palm image recognition server.

Step 304: Perform palm detection on the palm image to generate a palm box for the palm in the palm image.

The palm detection means determining the palm in the palm image and indicating the palm in the palm image in a form of the palm box. The palm box indicates a palm location of the to-be-determined object identifier, for example, a location of the palm, in the palm image. Other information such as the finger of the to-be-determined object or the scene in which the camera photographs the palm of the object is eliminated.

Step 306: Determine location information of the palm relative to the camera based on the palm box and the palm image.

For example, the computer device determines the location information between the palm and the palm image recognition device by comparing the palm box in the palm image with the palm image.

In some embodiments, the location information includes orientation information and distance information. The orientation information is an orientation relationship between the palm and the palm image recognition device. The distance information is a distance relationship between the palm and the palm image recognition device. In some embodiments, the location information is distance information and orientation information of the palm relative to a reference point when the camera in the palm image recognition device is used as the reference point.

Step 308: Display a palm identifier corresponding to the palm on the screen based on the location information, the palm identifier being used for indicating the palm to move to a preset spatial location corresponding to the camera, to perform recognition on a palm image captured by the camera at the preset spatial location to obtain an object identifier corresponding to the palm image.

The palm identifier is used for indicating the palm to move to the preset spatial location corresponding to the camera.

The preset spatial location is a location at which the camera can capture a palm image with optimal quality. To be specific, when the palm moves to the preset spatial location, the palm image captured by the camera has optimal quality, and the palm image can be quickly recognized. For example, the preset spatial location is pre-calibrated. In some embodiments, the palm is at a center location in the palm image when the palm moves to the preset spatial location.

For example, the comparison and recognition means performing recognition on a feature in a palm region and a preset palm feature in a database.

The preset palm feature is a stored palm feature of a palm of an object identifier. Each preset palm feature has a corresponding object identifier, which indicates that the preset palm feature belongs to the object identifier and is a palm feature of a palm of the object. The object identifier may be any object identifier. For example, the object identifier is an object identifier registered with a payment application, or the object identifier is an object identifier registered with an enterprise.

In this embodiment of this application, the computer device includes a database, and the database includes a plurality of preset palm features and an object identifier corresponding to each preset palm feature. In the database, one object identifier may correspond to one preset palm feature, or one object identifier may correspond to at least two preset palm features.

For example, a plurality of objects are registered with a payment application, a preset palm feature of each object is bound to a corresponding object identifier, and palm features of the plurality of objects are stored in the database with corresponding object identifiers. When an object subsequently uses the payment application, comparison and recognition are performed on a palm image captured by the camera and a preset palm feature in the database to determine an object identifier and verify an identify of the object.

To sum up, in the method provided in this embodiment, the palm image is obtained by using the camera; palm detection is performed on the palm image to generate the palm box for the palm in the palm image; the location information of the palm relative to the camera is determined based on the palm box and the palm image; and the palm identifier corresponding to the palm is displayed on the screen based on the location information, the palm identifier being used for indicating the palm to move to the preset spatial location corresponding to the camera, to perform recognition on the palm image captured by the camera at the preset spatial location to obtain the object identifier corresponding to the palm image. In this application, the location information of the palm relative to the camera is determined based on the palm image and the palm box in the palm image, the palm identifier corresponding to the palm is displayed based on the location information, and the palm is indicated, based on the palm identifier, to move to the preset spatial location corresponding to the camera. In this way, the object is guided to quickly move the palm to an appropriate palm swipe location. This improves recognition efficiency of palm image recognition.

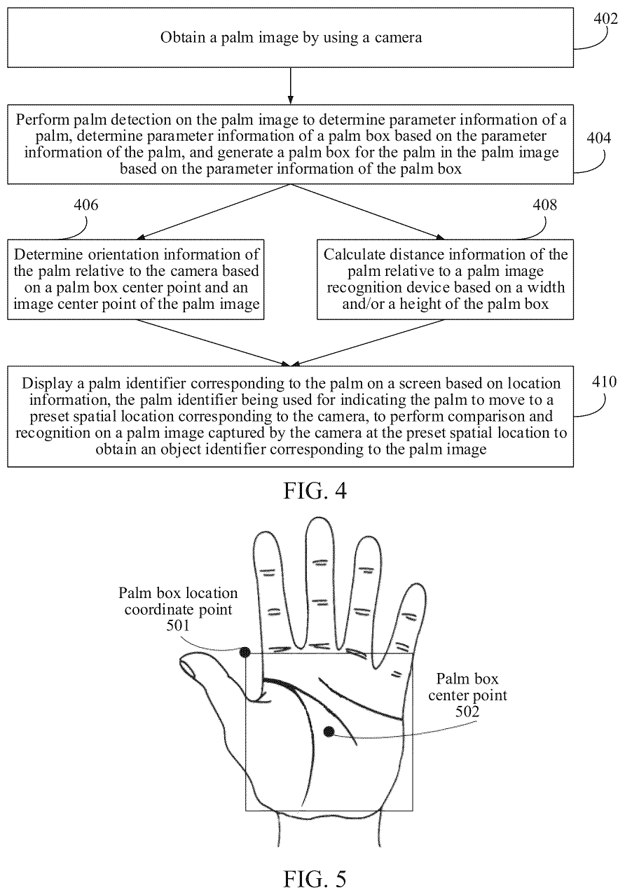

FIG. 4 is a flowchart of a palm image recognition method according to an exemplary embodiment of this application. The method is applied to a palm image recognition device with a camera and a large screen. The method may be performed by a computer device. The computer device may be the terminal 100 or the server 200 in FIG. 2. The method includes the following steps:

Step 402: Obtain a palm image by using the camera.

The palm image is a palm image of a to-be-determined object identifier. The palm image includes a palm. The palm is a palm of an object whose identity is to be verified. The palm image may further include other information, for example, a finger of the object or a scene in which the camera photographs the palm of the object.

For example, the computer device photographs the palm of the object to obtain the palm image. For example, the computer device is a palm image recognition device with a camera and a screen. The palm image includes the palm. The palm may be a left palm of the object or a right palm of the object. For example, the computer device is an Internet of Things device. The Internet of Things device photographs the left palm of the object by using the camera to obtain the palm image. The Internet of Things device may be a payment terminal for a merchant. For another example, when an object performs a transaction during shopping in a store, the object extends a palm to a camera of a payment terminal in the store, and the payment terminal in the store photographs the palm of the object by using the camera to obtain a palm image.

In an exemplary implementation, the computer device establishes a communication connection to another device, and receives, through the communication connection, a palm image transmitted by the another device. For example, the computer device is a payment application server, and the another device may be a payment terminal. The payment terminal photographs a palm of an object to obtain a palm image, and then transmits the palm image to the payment application server through a communication connection between the payment terminal and the payment application server, so that the payment application server can determine an object identifier for the palm image. For example, the computer device obtains a palm image from a palm image recognition device, where the palm image recognition device has a camera.

Step 404: Perform palm detection on the palm image to determine parameter information of the palm, determine parameter information of a palm box based on the parameter information of the palm, and generate a palm box for the palm in the palm image based on the parameter information of the palm box.

The palm detection means determining the palm in the palm image and indicating the palm in the palm image in a form of the palm box.

The parameter information of the palm includes a width, a height, and a palm center point of the palm.

The parameter information of the palm box includes a width, a height, and a palm box center point of the palm box.

For example, the computer device inputs the palm image to a palm box recognition model for image division to obtain at least two grids; the computer device predicts at least one palm box for each grid by using the palm box recognition model to obtain a confidence value corresponding to each predicted palm box; and the computer device determines the palm box for the palm in the palm image based on the confidence value corresponding to the predicted palm box.

For example, the computer device divides the palm image into 7×7 grids, and the computer device predicts two predicted palm boxes for each grid. Each predicted palm box includes five predicted values: x, y, w, h, and confidence, where x and y are used for representing location coordinates of a pixel in an upper left corner of the predicted palm box, w and h are used for representing a width and a height of the predicted palm box, and confidence is used for representing a confidence value of the predicted palm box. For example, categories corresponding to the two predicted palm boxes include: a grid obtained by dividing the palm image belonging to the palm box, and a grid obtained by dividing the palm image not belonging to the palm box. With respect to the confidence value corresponding to each predicted palm box, the computer device determines the palm box for the palm in the palm image based on the confidence value corresponding to each predicted palm box.

For example, FIG. 5 is a schematic diagram of a palm box on a palm. A palm box location coordinate point 501 is a pixel location corresponding to the palm box. A palm box center point 502 is a center point of the palm box. For example, coordinates of the palm box location coordinate point 501 are (x, y), a width of the palm box is w, and a height of the palm box is h. In this case, coordinates of the palm box center point 502 may be expressed as (x+w/2, y+h/2).

In an exemplary implementation, FIG. 6 is a schematic diagram of a finger seam point on a palm. The finger seam point is a first finger seam point 601 between an index finger and a middle finger, or the finger seam point is a second finger scam point 602 between the middle finger and a ring finger, or the finger seam point is a third finger seam point 603 between the ring finger and a little finger.

The palm in the palm image may be located in any region of the palm image. Therefore, to determine a location of the palm in the palm image, finger seam point detection is performed on the palm image to obtain at least one finger seam point of the palm, so that the palm box can be subsequently determined based on the at least one finger seam point.

In an exemplary implementation, the computer device performs image division on the palm image to obtain at least two grids; the computer device predicts at least one palm box for each grid by using the palm box recognition model to obtain a confidence value corresponding to each predicted palm box; and the computer device determines the palm box for the palm in the palm image based on the confidence value corresponding to the predicted palm box.

In some embodiments, the computer device obtains a sample palm image and a sample palm box corresponding to the sample palm image; the computer device performs data processing on the sample palm image by using the palm box recognition model to obtain a predicted palm box; and the computer device updates a model parameter of the palm box recognition model based on a difference between the predicted palm box and the sample palm box.

Step 406: Determine orientation information of the palm relative to the camera based on the palm box center point and an image center point of the palm image.

For example, the computer device determines location information between the palm and the palm image recognition device by comparing the palm box in the palm image with the palm image.

In some embodiments, the location information includes the orientation information and distance information.

The orientation information is an orientation relationship between the palm and the palm image recognition device.

The distance information is a distance relationship between the palm and the palm image recognition device.

For example, the computer device determines the orientation information of the palm relative to the camera based on the palm box center point and the image center point of the palm image. Specifically, an offset of the palm box center point relative to the image center point is determined as the orientation information, and the orientation information is used for indicating an offset direction of the palm relative to the camera. In an example, the orientation information is used for indicating a direction from the image center point to the palm box center point.

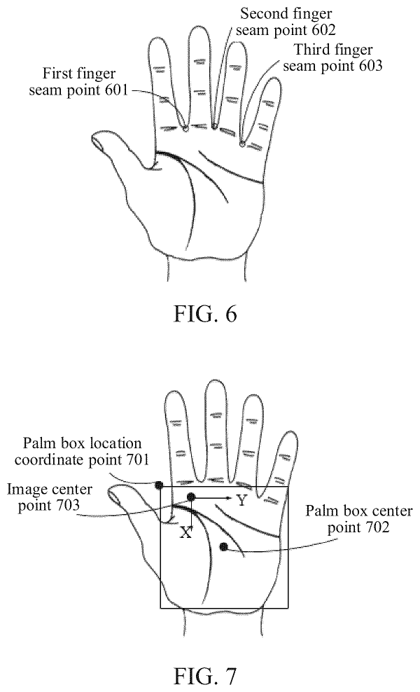

For example, FIG. 7 is a schematic diagram of a palm box on a palm. A palm box location coordinate point 701 is a pixel location corresponding to the palm box. A palm box center point 702 is a center point of the palm box. An image center point 703 is an image center point of a palm image. For example, coordinates of the image center point 703 are (W/2, H/2), where W is a width of the palm image, and H is a height of the palm image, coordinates of the palm box location coordinate point 701 are (x, y), a width of the palm box is w, and a height of the palm box is h. In this case, coordinates of the palm box center point 702 may be expressed as (x+w/2, y+h/2), and an offset of the palm box center point 702 relative to the image center point 703 may be expressed as follows: dx=x+w/2−W/2, and dy=y+h/2−H/2. For descriptions of the foregoing parameters, refer to step 404.

Step 408: Calculate distance information of the palm relative to the camera based on the width and/or the height of the palm box.

For example, the computer device calculates the distance information of the palm relative to the camera based on the width and/or the height of the palm box.

The distance information of the palm relative to the camera may be obtained by using the following four methods:

Method 1: The computer device calculates an area of the palm box based on the width and the height of the palm box; and the computer device compares the area of the palm box with a preset area threshold to obtain distance information of the palm relative to the camera.

For example, the area of the palm box is calculated based on the width and the height of the palm box, and the area of the palm box is compared with the preset area threshold to obtain the distance information of the palm relative to the camera. The distance information is used for indicating that the palm is close to or far away from the palm image recognition device.

In an example, the preset area threshold preset by the computer device is K, and the computer device compares the area of the palm box with the preset area threshold K. When the calculated area of the palm box is greater than the preset area threshold K, the palm is close to the palm image recognition device. On the contrary, when the calculated area of the palm box is less than the preset area threshold K, the palm is far away from the palm image recognition device.

In another example, the preset area threshold preset by the computer device includes a first area threshold K1 and a second area threshold K2, where K1 is greater than K2. When the area of the palm box is greater than K1, the palm is close to the palm image recognition device. When the area of the palm box is less than K2, the palm is far away from the palm image recognition device. In some embodiments, when the area of the palm box is less than or equal to K1 and greater than or equal to K2, the location information is used for indicating that a distance between the palm and the palm image recognition device is appropriate.

In some embodiments, at least one of the preset area threshold K, the first area threshold K1, and the second area threshold K2 that are preset by the computer device may be a preset empirical value, or may be determined based on a size of the palm image. The threshold increases as the size of the palm image increases.

Method 2: The computer device calculates a first distance value of the palm relative to the palm image recognition device based on the width of the palm box and a first threshold. The first threshold is a value of a preset width of the palm box.

For example, the first threshold is used for indicating standard widths of the palm box that correspond to at least two preset distances. A width scaling ratio is determined based on the first threshold, and first conversion between a width and a distance is performed on the width of the palm box based on the width scaling ratio to obtain the first distance value.

Specifically, for example, the first threshold corresponds to two preset distances. A first difference between the two preset distances is calculated, and a second difference between two standard widths that are in a one-to-one correspondence with the two preset distances is calculated. Both the first difference and the second difference are positive numbers. A ratio of the first difference to the second difference is determined as the width scaling ratio.

When the first threshold corresponds to more than two preset distances, two standard widths that are in a one-to-one correspondence with two preset distances corresponding to the first threshold are selected, and a width scaling ratio is calculated according to the foregoing descriptions. Two standard widths that are in a one-to-one correspondence with other two preset distances corresponding to the first threshold are selected, and a width scaling ratio is calculated according to the foregoing descriptions. An average value of at least two width scaling ratios is calculated, and the average value is determined as the width scaling ratio corresponding to the first threshold. In this embodiment, the process of selecting two standard widths that are in a one-to-one correspondence with two preset distances corresponding to the first threshold is performed at least n times, and two preset distances selected each time constitute a preset distance pair, where n is an integer greater than 1, and n preset distance pairs are obtained. The n preset distance pairs are different from each other.

Then a width difference between the width of the palm box and a first standard width is calculated, where the first standard width is a standard width corresponding to a minimum value of the at least two preset distances, that is, a standard width corresponding to a first preset distance. A product of the width difference and the width scaling ratio is added to the first preset distance to implement the first conversion between a width and a distance to obtain the first distance value.

For example, the first threshold specified by the computer device is values of preset widths of the palm box when the palm is respectively 50 mm and 300 mm away from the palm image recognition device. For example, a preset width of the palm box when the palm is 50 mm away from the palm image recognition device is w1, and a preset width of the palm box when the palm is 300 mm away from the palm image recognition device is w2. A width of the palm box that is obtained by the computer device is w.

In this case, a formula for calculating the first distance value based on the width of the palm box may be expressed as follows:

$${S}_{w} = \frac{300 - 50}{{w}_{2} - {w}_{1}} * ( w - {w}_{1} ) + 50$$

In the formula, S_{w} is the first distance value, w1 is the preset width of the palm box when the palm is 50 mm away from the palm image recognition device, w2 is the preset width of the palm box when the palm is 300 mm away from the palm image recognition device, and w is the width of the palm box that is obtained by the computer device.

Method 3: The computer device calculates a second distance value of the palm relative to the palm image recognition device based on the height of the palm box and a second threshold. The second threshold is a value of a preset height of the palm box.

For example, the second threshold is used for indicating standard heights of the palm box that correspond to at least two preset distances. A height scaling ratio is determined based on the second threshold, and second conversion between a height and a distance is performed on the height of the palm box based on the height scaling ratio to obtain the second distance value.

Specifically, for example, the second threshold corresponds to two preset distances. A first difference between the two preset distances is calculated, and a second difference between two standard heights that are in a one-to-one correspondence with the two preset distances is calculated. Both the first difference and the second difference are positive numbers. A ratio of the first difference to the second difference is determined as the height scaling ratio. For a case in which the second threshold corresponds to more than two preset distances, refer to the foregoing descriptions of the first threshold. This is not repeated herein.

Then a height difference between the height of the palm box and a first standard height is calculated, where the first standard height is a standard height corresponding to a minimum value of the at least two preset distances, that is, a standard height corresponding to a first preset distance. A product of the height difference and the height scaling ratio is added to the first preset distance to implement the second conversion between a height and a distance to obtain the second distance value.

For example, the second threshold specified by the computer device is values of preset heights of the palm box when the palm is respectively 50 mm and 300 mm away from the palm image recognition device. For example, a preset height of the palm box when the palm is 50 mm away from the palm image recognition device is h1, and a preset height of the palm box when the palm is 300 mm away from the palm image recognition device is h2. A height of the palm box that is obtained by the computer device is h.

In this case, a formula for calculating the second distance value based on the height of the palm box may be expressed as follows:

$${S}_{h} = \frac{300 - 50}{{h}_{2} - {h}_{1}} * ( h - {h}_{1} ) + 50$$

In the formula, Sₕ is the second distance value, h1 is the preset height of the palm box when the palm is 50 mm away from the palm image recognition device, h2 is the preset height of the palm box when the palm is 300 mm away from the palm image recognition device, and h is the height of the palm box that is obtained by the computer device.

Method 4: The computer device calculates a first distance value of the palm relative to the palm image recognition device based on the width of the palm box and a first threshold. The computer device calculates a second distance value of the palm relative to the palm image recognition device based on the height of the palm box corresponding to the palm and a second threshold. The computer device obtains the distance information of the palm relative to the camera based on the first distance value and the second distance value.

The computer device obtains the distance information of the palm relative to the camera based on both the first distance value and the second distance value. The first distance value and the second distance value may be obtained by using the formulas in Method 2 and Method 3. Details are not described herein again.

The computer device determines, by using max(S_{w}, Sₕ), whether a distance between the palm and the palm image recognition device exceeds a preset maximum distance, and determines, by using min(S_{w}, Sₕ), whether a distance between the palm and the palm image recognition device exceeds a preset minimum distance. When the distance is greater than the preset maximum distance, the palm is prompted to move close. When the distance is less than the preset minimum distance, the palm is prompted to move away.

Step 410: Display a palm identifier corresponding to the palm on the screen based on the location information, the palm identifier being used for indicating the palm to move to a preset spatial location corresponding to the camera, to perform recognition on a palm image captured by the camera at the preset spatial location to obtain an object identifier corresponding to the palm image.

For example, the palm identifier is used for indicating the palm to move to the preset spatial location corresponding to the camera. When the palm moves to the preset spatial location and the computer device is capable of recognizing the captured palm image, the computer device performs recognition on the palm image to obtain the object identifier corresponding to the palm image.

For example, the comparison and recognition means performing recognition on a feature in a palm region and a preset palm feature in a database.

The preset palm feature is a stored palm feature of a palm of an object identifier. Each preset palm feature has a corresponding object identifier, which indicates that the preset palm feature belongs to the object identifier and is a palm feature of a palm of the object. The object identifier may be any object identifier. For example, the object identifier is an object identifier registered with a payment application, or the object identifier is an object identifier registered with an enterprise.

As a biometric feature, a palm has biological uniqueness and differentiation. Compared with biometric feature recognition that is currently widely used in the fields of identity verification, payment, access control, bus riding, and the like, a palm is not affected by makeup, masks, sunglasses, or the like. This can improve accuracy of object verification. In some scenarios, for example, in a high temperature scenario in summer, sunglasses, a sun hat, or the like needs to be put on, leading to facial coverage. In this case, using a palm image for identity verification may be a more convenient choice.

Cross-device registration recognition is a capability that is quite important for experience of an object. For two types of devices that are associated, an object may be registered with one type of device, an object identifier of the object is bound to a palm feature of the object, and then an identity of the object may be verified on the other type of device. A mobile phone and an Internet of Things device differ greatly in an image style and image quality. Through cross-device registration recognition, an object may directly use the Internet of Things device after being registered with the mobile phone, and the object does not need to be registered with two types of devices. For example, after the object is registered with the mobile phone, an identity of the object may be directly verified on a device in a store, and the object does not need to be registered with the device in the store. This avoids leakage of information of the object.

In an exemplary implementation, the computer device displays the palm identifier corresponding to the palm on the screen based on the location information, and the computer device moves the camera based on the palm identifier to move the preset spatial location of the camera to a location of the palm and perform photographing, and performs recognition on the palm image captured by the camera to obtain the object identifier corresponding to the palm image.

To sum up, in the method provided in this embodiment, the palm image is obtained by using the camera; palm detection is performed on the palm image to obtain the palm box for the palm in the palm image; the orientation information and the distance information of the palm relative to the camera are determined based on the palm box and the palm image; and the palm identifier corresponding to the palm is displayed based on the orientation information and the distance information, the palm identifier being used for indicating the palm to move to the preset spatial location corresponding to the camera, to perform recognition on the palm image captured by the camera at the preset spatial location to obtain the object identifier corresponding to the palm image. In this application, the orientation information and the distance information of the palm relative to the camera are determined based on the palm image and the palm box in the palm image, the palm identifier corresponding to the palm is displayed based on the orientation information and the distance information, and the palm is indicated, based on the palm identifier, to move to the preset spatial location corresponding to the camera. In this way, the object is guided to quickly move the palm to an appropriate palm swipe location. This improves recognition efficiency of palm image recognition.

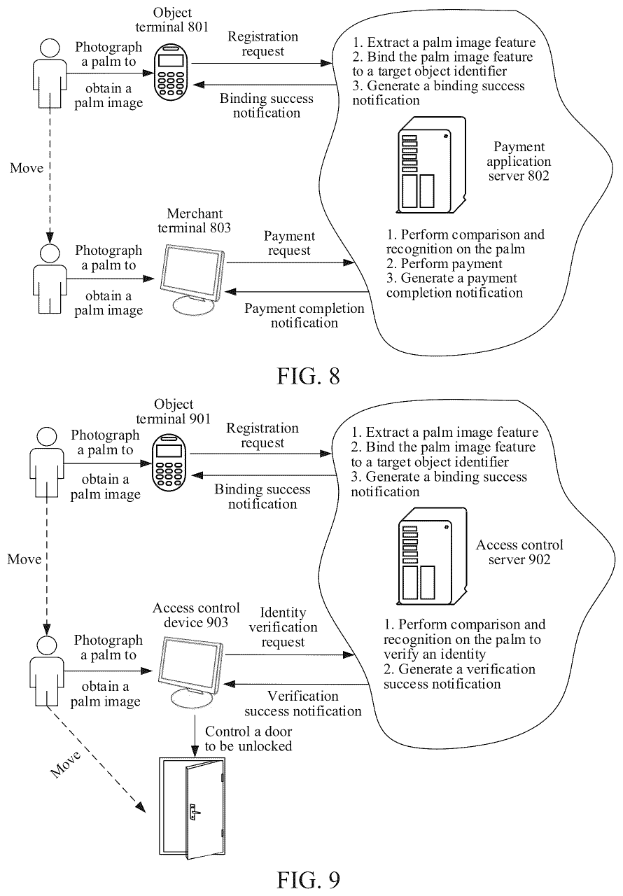

FIG. 8 is a schematic diagram of cross-device payment based on a palm image recognition method according to an exemplary embodiment of this application. The method relates to an object terminal 801, a merchant terminal 803, and a payment application server 802.

A payment application is installed on the object terminal 801. The object terminal 801 logs in to the payment application based on an object identifier, and establishes a communication connection to the payment application server 802. The object terminal 801 may interact with the payment application server 802 through the communication connection. A payment application is also installed on the merchant terminal 803. The merchant terminal 803 logs in to the payment application based on a merchant identifier, and establishes a communication connection to the payment application server 802. The merchant terminal 803 may interact with the payment application server 802 through the communication connection.

The cross-device payment process includes the following steps:

1. An object holds the object terminal 801 at home, photographs a palm of the object by using the object terminal 801 to obtain a palm image of the object, logs in to the payment application based on an object identifier, and transmits a palm image registration request to the payment application server 802, the palm image registration request carrying the object identifier and the palm image.

2. The payment application server 802 receives the palm image registration request transmitted by the object terminal 801, processes the palm image to obtain a palm feature of the palm image, stores the palm feature in correspondence with the object identifier, and transmits a palm image binding success notification to the object terminal 801.

The payment application server 802 uses the palm feature as a preset palm feature after storing the palm feature in correspondence with the object identifier. Subsequently, the corresponding object identifier may be determined based on the stored preset palm feature.

3. The object terminal 801 receives the palm image binding success notification and displays the palm image binding success notification to notify the object that the palm image is bound to the object identifier.

The object registers the palm image through interaction between the object terminal 801 and the payment application server 802, and may subsequently implement automatic payment by using a palm image.

4. When the object performs a transaction for buying a product in a store, the merchant terminal 803 photographs the palm of the object to obtain a palm image, logs in to the payment application based on a merchant identifier, and transmits a payment request to the payment application server 802, the payment request carrying the merchant identifier, an amount of consumption, and the palm image.

5. After receiving the payment request, the payment application server 802 performs recognition on the palm image to determine an object identifier for the palm image, determines an account for the object identifier in the payment application, performs a transfer by using the account, and transmits a payment completion notification to the merchant terminal 803 after the transfer is completed.

After registering the palm image by using the object terminal 801, the object may directly pay on the merchant terminal 803 by using the palm, without registering a palm image on the merchant terminal 803. This implements cross-device palm image recognition and improves convenience.

6. The merchant terminal 803 receives the payment completion notification and displays the payment completion notification to notify the object that the payment is completed, so that the object and the merchant complete the transaction on the product and the object can take the product away.

In addition, in the process of implementing cross-device payment by the object terminal 801 and the merchant terminal 803 in the foregoing embodiment, the merchant terminal 803 may alternatively be replaced with a payment device on a bus, and a cross-device riding payment solution is implemented according to the foregoing steps.

FIG. 9 is a schematic diagram of cross-device identity verification based on a palm image recognition method according to an exemplary embodiment of this application. The method relates to an object terminal 901, an access control device 903, and an access control server 902.

The object terminal 901 establishes a communication connection to the access control server 902, and the object terminal 901 may interact with the access control server 902 through the communication connection. The access control device 903 establishes a communication connection to the access control server 902, and the access control device 903 may interact with the access control server 902 through the communication connection.

The cross-device identity verification process includes the following steps:

1. An object holds the object terminal 901 at home, photographs a palm of the object by using the object terminal 901 to obtain a palm image of the object, and transmits a palm registration request to the access control server 902, the palm registration request carrying an object identifier and the palm image.

2. The access control server 902 receives the palm registration request transmitted by the object terminal 901, processes the palm image to obtain a palm feature of the palm image, stores the palm feature in correspondence with the object identifier, and transmits a palm binding success notification to the object terminal 901.

The access control server 902 may use the palm feature as a preset palm feature after storing the palm feature in correspondence with the object identifier. Subsequently, the corresponding object identifier may be determined based on the stored preset palm feature.

3. The object terminal 901 receives the palm binding success notification and displays the palm binding success notification to notify the object that the palm image is bound to the object identifier.

The object registers the palm image through interaction between the object terminal 901 and the access control server, and may subsequently implement automatic door unlocking by using a palm image.

4. When the object returns home, the access control device 903 photographs the palm of the object to obtain a palm image of the object, and transmits an identity verification request to the access control server 902, the identity verification request carrying the to-be-verified palm image.

5. The access control server 902 receives the identity verification request transmitted by the access control device 903, recognizes the to-be-verified palm image to obtain an object identifier for the palm image, determines that the object is a registered object, and transmits a verification success notification to the access control device 903.

6. The access control device 903 receives the verification success notification transmitted by the access control server 902, and controls a door to be unlocked based on the verification success notification, so that the object can enter a room.

In the foregoing embodiment, the process of implementing cross-device identity verification by the object terminal 901 and the access control device 903 is described.

It can be learned from the foregoing cross-device identity verification scenario that, regardless of a palm registration stage in which the object terminal 901 interacts with the access control server 902 or a palm image recognition stage in which the object terminal 901 interacts with the server through another terminal device, the object terminal 901 or the another terminal device obtains a palm image and then transmits the palm image to the server, and the server performs comparison and recognition. In addition, in the comparison and recognition stage, the access control server 902 compares the palm feature with the preset palm feature to obtain a recognition result for a current object.

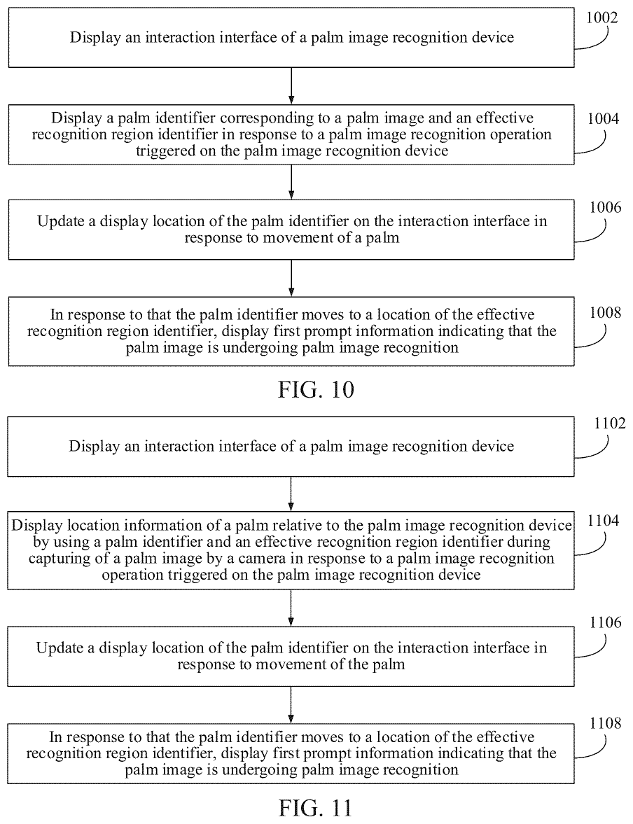

FIG. 10 is a flowchart of a palm identifier display method according to an exemplary embodiment of this application. The method is applied to a palm image recognition device with a camera and a large screen. The method may be performed by a computer device. The computer device may be the terminal 100 or the server 200 in FIG. 2. The method includes the following steps:

Step 1002: Display an interaction interface of the palm image recognition device.

The palm image recognition device is a device that can provide a palm image recognition function.

The interaction interface is an interface that can perform display and provide an interaction function.

In some embodiments, the interaction function means that an object implements functional control on the palm image recognition device through an operation such as tapping, sliding, double-tapping, or triple-tapping.

The palm image is a palm image of a to-be-determined object identifier. The palm image includes a palm. The palm is a palm of an object whose identity is to be verified. The palm image may further include other information, for example, a finger of the object or a scene in which the camera photographs the palm of the object.

For example, the palm image may be obtained by the camera of the palm image recognition device in the computer device by photographing the palm of the object whose identity is to be verified, or may be captured and transmitted by a camera carried in another device.

For example, the computer device is a payment device in a store, and the payment device in the store photographs a palm of an object by using a camera to obtain a palm image. Alternatively, the computer device is a palm image recognition server, and a payment device in a store captures a palm image of an object by using a camera and then transmits the palm image to the palm image recognition server.

Step 1004: Display a palm identifier corresponding to the palm image and an effective recognition region identifier in response to a palm image recognition operation triggered on the palm image recognition device.

The palm identifier is used for indicating the palm to move to a preset spatial location corresponding to the camera.

The effective recognition region identifier is used for indicating the preset spatial location corresponding to the camera.

The preset spatial location is a location at which the camera can capture a palm image with optimal quality. To be specific, when the palm moves to the preset spatial location, the palm image captured by the camera has optimal quality, and the palm image can be quickly recognized.

Step 1006: Update a display location of the palm identifier on the interaction interface in response to movement of the palm.

For example, the computer device updates the display location of the palm identifier on the interaction interface in response to the movement of the palm.

For example, the computer device indicates the palm on the interaction interface by using the palm identifier. On the interaction interface, the palm identifier is located in the lower left of the effective recognition region identifier. In this case, it can be learned that the palm is also located in the lower left of the camera. When the palm moves, the display location of the palm identifier on the interaction interface also moves correspondingly.

Step 1008: In response to that the palm identifier moves to a location of the effective recognition region identifier, display first prompt information indicating that the palm image is undergoing palm image recognition.

For example, in response to that the palm identifier moves to the location of the effective recognition region identifier, the computer device displays the first prompt information indicating that the palm image is undergoing palm image recognition.

In some embodiments, in response to that the palm identifier moves to the location of the effective recognition region identifier, the computer device displays the first prompt information indicating that the palm image is undergoing palm image recognition, and cancels the display of the palm identifier.

For example, when the palm identifier moves to the effective recognition region identifier and the palm image is recognizable, the first prompt information indicating that the palm image is undergoing palm image recognition is displayed, and the display of the palm identifier is canceled. For example, the first prompt information is displayed as “Palm image recognition is in progress”.

To sum up, in the method provided in this embodiment, the interaction interface of the palm image recognition device is displayed; the palm identifier corresponding to the palm image and the effective recognition region identifier are displayed in response to the palm image recognition operation triggered on the palm image recognition device; the display location of the palm identifier on the interaction interface is updated in response to the movement of the palm; and in response to that the palm identifier moves to the location of the effective recognition region identifier, the first prompt information indicating that the palm image is undergoing palm image recognition is displayed. In this application, the palm corresponding to an object is displayed as the palm identifier on the interface, the preset spatial location corresponding to the camera is displayed as the effective recognition region identifier on the interaction interface, and relative location information between the palm identifier and the effective recognition region identifier is displayed on the interaction interface to represent location information between the palm and the camera, to guide the object to quickly move the palm to an appropriate palm swipe location. This improves recognition efficiency of palm image recognition.

FIG. 11 is a flowchart of a palm identifier display method according to an exemplary embodiment of this application. The method is applied to a palm image recognition device with a camera and a large screen. The method may be performed by a computer device. The computer device may be the terminal 100 or the server 200 in FIG. 2. The method includes the following steps:

Step 1102: Display an interaction interface of the palm image recognition device.

The palm image recognition device is a device that can provide a palm image recognition function.

The interaction interface is an interface that can perform display and provide an interaction function.

The palm image is a palm image of a to-be-determined object identifier. The palm image includes a palm. The palm is a palm of an object whose identity is to be verified. The palm image may further include other information, for example, a finger of the object or a scene in which the camera photographs the palm of the object. For example, the computer device photographs the palm of the object to obtain the palm image. The palm image includes the palm. The palm may be a left palm of the object or a right palm of the object. For example, the computer device is an Internet of Things device. The Internet of Things device photographs the left palm of the object by using the camera to obtain the palm image. The Internet of Things device may be a payment terminal for a merchant. For another example, when an object performs a transaction during shopping in a store, the object extends a palm to a camera of a payment terminal in the store, and the payment terminal in the store photographs the palm of the object by using the camera to obtain a palm image.

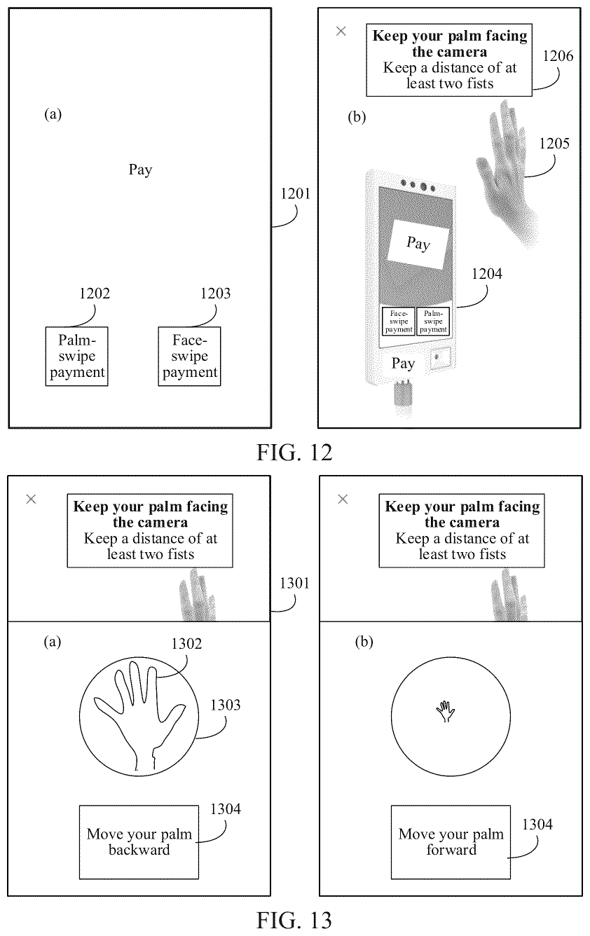

In an exemplary implementation, the computer device establishes a communication connection to another device, and receives, through the communication connection, a palm image transmitted by the another device. For example, the computer device is a payment application server, and the another device may be a payment terminal. The payment terminal photographs a palm of an object to obtain a palm image, and then transmits the palm image to the payment application server through a communication connection between the payment terminal and the payment application server, so that the payment application server can determine an object identifier for the palm image. For example, FIG. 12 is a schematic diagram of an interaction interface of a palm image recognition device. As shown in a diagram (a) in FIG. 12, smart payment is used as an example. Functional buttons, that is, a palm-swipe payment button 1202 and a face-swipe payment button 1203, are displayed on the interaction interface 1201 of the palm image recognition device. When an object triggers the palm-swipe payment button 1202, a schematic guidance diagram for palm image recognition is displayed on the interaction interface 1201 of the palm image recognition device. As shown in a diagram (b) in FIG. 12, the schematic guidance diagram for palm image recognition includes a palm image recognition device picture 1204, a palm picture 1205, and guidance information 1206. The schematic guidance diagram for palm image recognition directly shows how a palm faces the palm image recognition device and an optimal location of the palm relative to the palm image recognition device during palm image recognition. In addition, the guidance information 1206 indicates the optimal location of the palm relative to the palm image recognition device during palm image recognition. In an exemplary implementation, the computer device displays second prompt information in response to a palm image recognition operation triggered on the palm image recognition device.

The second prompt information is used for indicating the palm identifier to move to a location of an effective recognition region identifier.

Step 1104: Display location information of the palm relative to the camera by using the palm identifier and the effective recognition region identifier during capturing of the palm image by the camera in response to the palm image recognition operation triggered on the palm image recognition device.

The palm identifier includes the location information of the palm relative to the camera.

The effective recognition region identifier is used for indicating a preset spatial location corresponding to the camera.

The preset spatial location is a location at which the camera can capture a palm image with optimal quality. To be specific, when the palm moves to the preset spatial location, the palm image captured by the camera has optimal quality, and the palm image can be quickly recognized. For example, the computer device displays the location information of the palm relative to the camera by using the palm identifier and the effective recognition region identifier during capturing of the palm image by the camera in response to the palm image recognition operation triggered on the palm image recognition device. In some embodiments, the location information includes orientation information; and the computer device displays relative location information between the palm identifier and the effective recognition region identifier to represent orientation information between the palm and the camera in response to the palm image recognition operation triggered on the palm image recognition device.

In some embodiments, the location information includes distance information; and the computer device displays a shape change of the palm identifier to represent distance information between the palm and the camera in response to the palm image recognition operation triggered on the palm image recognition device.

For example, FIG. 13 is a schematic diagram of location information of a palm relative to a palm image recognition device. As shown in a diagram (a) in FIG. 13, the computer device displays orientation information of the palm relative to a camera on an interaction interface 1301 by using location information of a palm identifier 1302 relative to an effective recognition region identifier 1303. In the diagram (a) in FIG. 13, on the interaction interface 1301, the palm identifier 1302 is at a middle location in the effective recognition region identifier 1303. In this case, it can be learned that the palm is also located directly in front of the camera.

The computer device displays distance information between the palm and the camera by using a shape change of the palm identifier 1302 on the interaction interface 1301. When the palm identifier 1302 is at a location of the effective recognition region identifier 1303 on the interaction interface 1301 and the palm is close to the camera, the computer device indicates the distance between the palm and the camera by enlarging a shape of the palm identifier 1302 on the interaction interface 1301, and displays second prompt information 1304 “Move your palm backward” on the interaction interface 1301.

As shown in a diagram (b) in FIG. 13, when the palm identifier 1302 is at the location of the effective recognition region identifier 1303 on the interaction interface 1301 and the palm is far away from the camera, the computer device indicates the distance between the palm and the camera by narrowing a shape of the palm identifier 1302 on the interaction interface 1301, and displays second prompt information 1304 “Move your palm forward” on the interaction interface 1301.

Step 1106: Update a display location of the palm identifier on the interaction interface in response to movement of the palm.

For example, the computer device updates the display location of the palm identifier on the interaction interface in response to the movement of the palm.

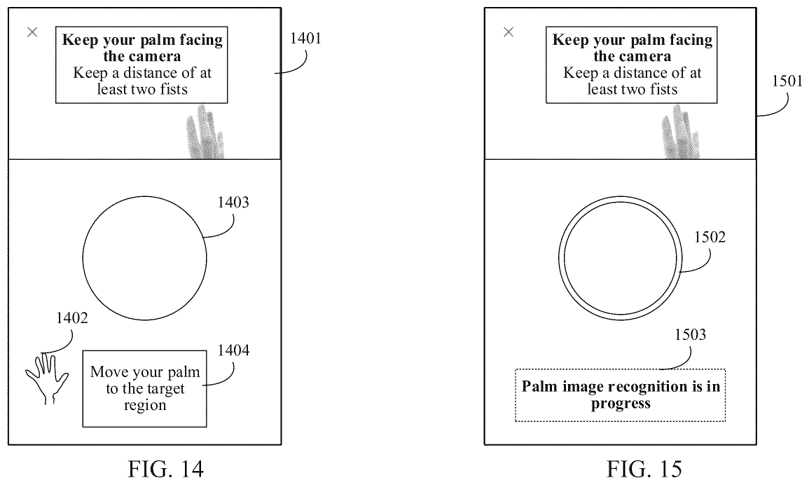

For example, the computer device indicates the palm on the interaction interface by using the palm identifier. On the interaction interface, the palm identifier is located in the lower left of the effective recognition region identifier. In this case, it can be learned that the palm is also located in the lower left of the camera. When the palm moves, the display location of the palm identifier on the interaction interface also moves correspondingly. For example, FIG. 14 is a schematic diagram of a palm identifier relative to an effective recognition region identifier. As shown in FIG. 14, the computer device displays orientation information of a palm relative to a camera on an interaction interface 1401 by using location information of a palm identifier 1402 relative to an effective recognition region identifier 1403. On the interaction interface 1401, the palm identifier 1402 is located in the lower left of the effective recognition region identifier 1403. In this case, it can be learned that the palm is also located in the lower left of the camera. When the palm identifier 1402 is not at a location of the effective recognition region identifier 1403, second prompt information 1404 “Move your palm to the target region” is displayed on the interaction interface 1401.

Step 1108: In response to that the palm identifier moves to the location of the effective recognition region identifier, display first prompt information indicating that the palm image is undergoing palm image recognition.

For example, in response to that the palm identifier moves to the location of the effective recognition region identifier, the computer device displays the first prompt information indicating that the palm image is undergoing palm image recognition.

In some embodiments, in response to that the palm identifier moves to the location of the effective recognition region identifier, the computer device displays the first prompt information indicating that the palm image is undergoing palm image recognition, and cancels the display of the palm identifier.

For example, when the palm identifier moves to the effective recognition region identifier and the palm image is recognizable, the first prompt information indicating that the palm image is undergoing palm image recognition is displayed, and the display of the palm identifier is canceled. For example, the first prompt information is displayed as “Palm image recognition is in progress”. For example, FIG. 15 is a schematic diagram of an interaction interface on which palm image recognition is in progress. When a palm identifier moves to an effective recognition region identifier 1502 and a palm image is recognizable, first prompt information 1503 “Palm image recognition is in progress” indicating that the palm image is undergoing palm image recognition is displayed on an interaction interface 1501, and the display of the palm identifier is canceled.

To sum up, in the method provided in this embodiment, the interaction interface of the palm image recognition device is displayed; the location information of the palm relative to the camera is displayed by using the palm identifier and the effective recognition region identifier during capturing of the palm image by the camera in response to the palm image recognition operation triggered on the palm image recognition device; the display location of the palm identifier on the interaction interface is updated in response to the movement of the palm; and in response to that the palm identifier moves to the location of the effective recognition region identifier, the first prompt information indicating that the palm image is undergoing palm image recognition is displayed. In this application, the palm corresponding to an object is displayed as the palm identifier on the interface, the preset spatial location corresponding to the camera is displayed as the effective recognition region identifier on the interaction interface, and the relative location information between the palm identifier and the effective recognition region identifier is displayed on the interaction interface to represent location information between the palm and the camera, to guide the object to quickly move the palm to an appropriate palm swipe location. This improves recognition efficiency of palm image recognition.

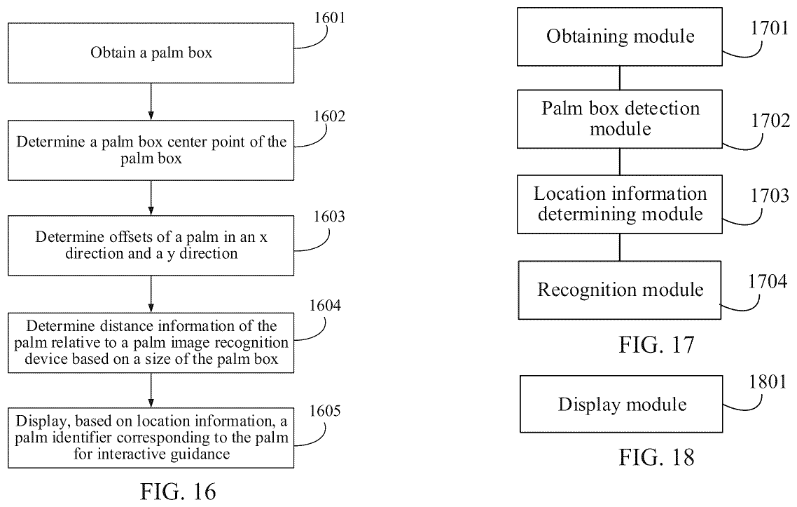

FIG. 16 is a flowchart of a palm image recognition method according to an exemplary embodiment of this application. The method may be performed by a computer device. The computer device may be the terminal 100 or the server 200 in FIG. 2. The method includes the following steps:

Step 1601: Obtain a palm box.

For example, the computer device obtains a palm image by using a camera, the computer device performs palm detection on the palm image to determine parameter information of a palm, the computer device determines parameter information of a palm box based on the parameter information of the palm, and the computer device generates a palm box for the palm in the palm image based on the parameter information of the palm box.

The parameter information of the palm box includes a width, a height, and a palm box center point of the palm box.

Step 1602: Determine the palm box center point of the palm box.

The parameter information of the palm includes a width, a height, and a palm center point of the palm. The parameter information of the palm box corresponds to the parameter information of the palm. The computer device determines the palm box center point based on the parameter information of the palm.

For example, a palm box location coordinate point is a pixel location corresponding to the palm box, and the palm box center point is a center point of the palm box. For example, coordinates of the palm box location coordinate point are (x, y), the width of the palm box is w, and the height of the palm box is h. In this case, coordinates of the palm box center point may be expressed as (x+w/2, y+h/2).

Step 1603: Determine offsets of the palm in an x direction and a y direction.

For example, the computer device determines the offsets of the palm in the x direction and the y direction, that is, determines orientation information of the palm relative to the camera, based on the palm box center point and an image center point of the palm image.

Step 1604: Determine distance information of the palm relative to a palm image recognition device based on a size of the palm box.

For example, the computer device calculates the distance information of the palm relative to the camera based on the width and/or the height of the palm box. In some embodiments, the computer device calculates an area of the palm box based on the width and the height of the palm box; and the computer device compares the area of the palm box with a preset area threshold to obtain distance information of the palm relative to the camera.

Step 1605: Display, based on location information, a palm identifier corresponding to the palm for interactive guidance.

For example, the computer device displays the palm identifier corresponding to the palm on a screen based on the orientation information and the distance information of the palm relative to the camera, and provides interactive guidance for an object based on the palm identifier.

To sum up, in the method provided in this embodiment, the palm box for the palm in the palm image is obtained; the offsets of the palm relative to the palm image in the x direction and the y direction are determined based on the palm box and the palm image, and the distance information of the palm relative to the camera is determined based on the size of the palm box; and the palm identifier corresponding to the palm is displayed based on the orientation information and the distance information, and interactive guidance is performed. In this application, the orientation information and the distance information of the palm relative to the camera are determined based on the palm image and the palm box in the palm image, the palm identifier corresponding to the palm is displayed based on the orientation information and the distance information, and the palm is indicated, based on the palm identifier, to move to a preset spatial location corresponding to the camera. In this way, the object is guided to quickly move the palm to an appropriate palm swipe location. This improves recognition efficiency of palm image recognition.

For example, application scenarios of the palm image recognition method provided in the embodiments of this application include but are not limited to the following scenarios: For example, in a smart payment scenario, a computer device of a merchant photographs a palm of an object to obtain a palm image of the object, and performs palm detection on the palm image by using the palm image recognition method provided in this application to generate a palm box for the palm in the palm image; determines location information of the palm relative to a palm image recognition device based on the palm box and the palm image; displays a palm identifier corresponding to the palm on a screen based on the location information, the palm identifier being used for indicating the palm to move to a preset spatial location corresponding to a camera, and guiding the object to adjust a location of the palm, so that the computer device can capture an image of the palm at the preset spatial location; and performs recognition on the palm image captured by the camera at the preset spatial location to determine an object identifier for the palm image, and transfers some resources in a resource account corresponding to the object identifier to a resource account of the merchant to implement palm-based automatic payment. For another example, in a cross-device payment scenario, an object may use a personal mobile phone at home or in other private space to complete identity registration to bind an account of the object to a palm image of the object. The palm image of the object may be captured on a personal terminal such as the personal mobile phone, or may be captured on a device in a store. Further, the palm image of the object may be recognized on the device in the store to determine the account of the object, and payment is directly performed by using the account. For example, the device in the store is a palm image recognition device with a camera and a screen, and is also referred to as a computer device of a merchant.

For still another example, in a clock-in scenario, a computer device photographs a palm of an object to obtain a palm image of the object, determines an object identifier for the palm image by using the palm image recognition method provided in the embodiments of this application, establishes a clock-in mark for the object identifier, and determines that clock-in is completed for the object identifier at current time. The computer device in the embodiments may be implemented as an access control device. Further, the access control device has a camera and a screen, and has a palm image recognition function.

Certainly, in addition to the foregoing scenarios, the method provided in the embodiments of this application may be further applied to other scenarios in which palm image recognition is required. Specific application scenarios are not limited in the embodiments of this application.

FIG. 17 is a schematic structural diagram of a palm image recognition apparatus according to an exemplary embodiment of this application. The apparatus may be implemented as all or a part of a computer device by using software, hardware, or a combination of software and hardware. The apparatus includes:
an obtaining module 1701, configured to perform step 302 in the embodiment corresponding to FIG. 3;
a palm box detection module 1702, configured to perform step 304 in the embodiment corresponding to FIG. 3;
a location information determining module 1703, configured to perform step 306 in the embodiment corresponding to FIG. 3; and
a recognition module 1704, configured to perform step 308 in the embodiment corresponding to FIG. 3.

In an exemplary implementation, the palm box detection module 1702 is configured to perform step 404 in the embodiment corresponding to FIG. 4, the parameter information of the palm box including a width, a height, and a palm box center point of the palm box.

In an exemplary implementation, the location information includes orientation information, and the location information determining module 1703 is configured to perform step 406 in the embodiment corresponding to FIG. 4.

In an exemplary implementation, the location information includes distance information, and the location information determining module 1703 is configured to perform step 408 in the embodiment corresponding to FIG. 4.

In an exemplary implementation, the location information determining module 1703 is configured to: calculate an area of the palm box based on the width and the height of the palm box; and compare the area of the palm box with a preset area threshold to obtain the distance information of the palm relative to the camera.

In an exemplary implementation, the location information determining module 1703 is configured to calculate a first distance value of the palm relative to the palm image recognition device based on the width of the palm box and a first threshold, the first threshold being a value of a preset width of the palm box.

In an exemplary implementation, the location information determining module 1703 is configured to calculate a second distance value of the palm relative to the palm image recognition device based on the height of the palm box and a second threshold, the second threshold being a value of a preset height of the palm box.

In an exemplary implementation, the location information determining module 1703 is configured to: calculate a first distance value of the palm relative to the palm image recognition device based on the width of the palm box and a first threshold; calculate a second distance value of the palm relative to the palm image recognition device based on the height of the palm box corresponding to the palm and a second threshold; and obtain the distance information of the palm relative to the camera based on the first distance value and the second distance value.

In an exemplary implementation, the palm box detection module 1702 is configured to: perform image division on the palm image to obtain at least two grids; predict at least one palm box for each grid by using a palm box recognition model to obtain a confidence value corresponding to each predicted palm box; and determine the palm box for the palm in the palm image based on the confidence value corresponding to the predicted palm box.

In an exemplary implementation, the palm box detection module 1702 is configured to: obtain a sample palm image and a sample palm box corresponding to the sample palm image; perform data processing on the sample palm image by using the palm box recognition model to obtain a predicted palm box; and update a model parameter of the palm box recognition model based on a difference between the predicted palm box and the sample palm box.

FIG. 18 is a schematic structural diagram of a palm identifier display apparatus according to an exemplary embodiment of this application. The apparatus may be implemented as all or a part of a computer device by using software, hardware, or a combination of software and hardware. The apparatus includes:
a display module 1801, configured to perform step 1002 in the embodiment corresponding to FIG. 10,
the display module 1801 being further configured to perform step 1004 in the embodiment corresponding FIG. 10, the palm identifier being used for representing a spatial location of a palm relative to the palm image recognition device, and the effective recognition region identifier being used for indicating a preset spatial location corresponding to the camera;
the display module 1801 being further configured to perform step 1006 in the embodiment corresponding FIG. 10, the display location corresponding to a location of the palm in front of the camera; and
the display module 1801 being further configured to perform step 1008 in the embodiment corresponding to FIG. 10.

In an exemplary implementation, the display module 1801 is configured to perform step 1104 in the embodiment corresponding to FIG. 11.

In an exemplary implementation, the location information includes orientation information, and the display module 1801 is configured to display relative location information between the palm identifier and the effective recognition region identifier to represent the orientation information between the palm and the camera in response to the palm image recognition operation triggered on the palm image recognition device.

In an exemplary implementation, the location information includes distance information, and the display module 1801 is configured to display a shape change of the palm identifier to represent the distance information between the palm and the camera in response to the palm image recognition operation triggered on the palm image recognition device.

In an exemplary implementation, the display module 1801 is configured to display second prompt information in response to the palm image recognition operation triggered on the palm image recognition device, the second prompt information being used for indicating the palm identifier to move to the location of the effective recognition region identifier.

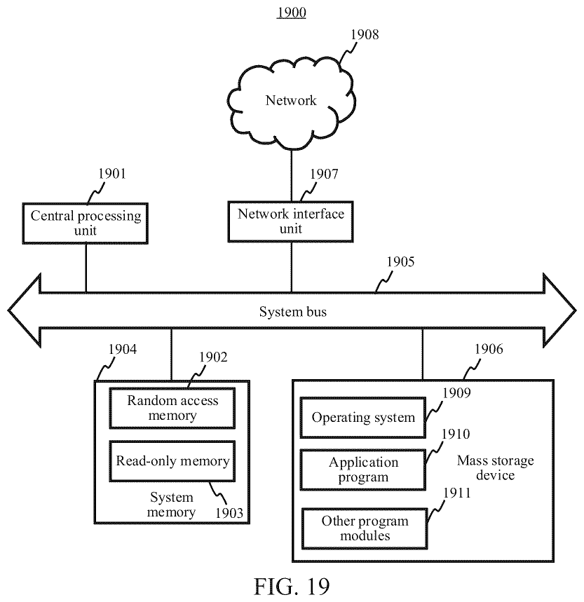

FIG. 19 is a structural block diagram of a computer device 1900 according to an exemplary embodiment of this application. The computer device may be implemented as the server in the foregoing solutions of this application. The image computer device 1900 includes a central processing unit (CPU) 1901, a system memory 1904 including a random access memory (RAM) 1902 and a read-only memory (ROM) 1903, and a system bus 1905 connecting the system memory 1904 to the CPU 1901. The image computer device 1900 further includes a mass storage device 1906 configured to store an operating system 1909, an application program 1910, and another program module 1911.

The mass storage device 1906 is connected to the CPU 1901 by using a mass storage controller (not shown) connected to the system bus 1905. The mass storage device 1906 and a computer-readable medium associated with the mass storage device provide non-volatile storage for the image computer device 1900. That is, the mass storage device 1906 may include a computer-readable medium (not shown) such as a hard disk or a compact disc read-only memory (CD-ROM) drive. In general, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, an erasable programmable read-only memory (EPROM), an electrically erasable programmable read-only memory (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may learn that the computer storage medium is not limited to the foregoing several types. The system memory 1904 and the mass storage device 1906 may be collectively referred to as a memory. According to the embodiments of the present disclosure, the image computer device 1900 may be further connected, through a network such as the Internet, to a remote computer on the network for running. That is, the image computer device 1900 may be connected to a network 1908 by using a network interface unit 1907 connected to the system bus 1905, or may be connected to another type of network or a remote computer system (not shown) by using a network interface unit 1907.

The memory further includes at least one computer program. The at least one computer program is stored in the memory. The CPU 1901 executes the at least one program to implement all or some of the steps in the palm image recognition method or the palm identifier display method shown in the foregoing embodiments.

An embodiment of this application further provides a computer device, the computer device including a processor and a memory, the memory storing at least one program, and the at least one program being loaded and executed by the processor to implement the palm image recognition method or the palm identifier display method provided in the foregoing method embodiments.

An embodiment of this application further provides a computer-readable storage medium, the storage medium storing at least one computer program, and the at least one computer program being loaded and executed by a processor to implement the palm image recognition method or the palm identifier display method provided in the foregoing method embodiments.

An embodiment of this application further provides a computer program product, the computer program product including a computer program, the computer program being stored in a computer-readable storage medium, and a processor of a computer device reading the computer program from the computer-readable storage medium and executing the computer program, so that the computer device performs the palm image recognition method or the palm identifier display method provided in the foregoing method embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules or units. Moreover, each module can be part of an overall module that includes the functionalities of the module. It can be understood that the embodiments of this application involve processing of user data related to user identities or characteristics, for example, data, historical data, and profiles. When the foregoing embodiments of this application are applied to a specific product or technology, user permission or consent is required, and collection, use, and processing of related data need to comply with related laws, regulations, and standards in related countries and regions.

What is claimed is:

1. A palm image recognition method performed by a computer device, and the method comprising:
performing palm detection on a palm image captured by a camera to generate a palm box for a palm in the palm image;
determining location information of the palm relative to the camera based on the palm box and the palm image; and
displaying a palm identifier corresponding to the palm based on the location information, the palm identifier being used for indicating the palm to move to a preset spatial location corresponding to the camera to obtain an object identifier corresponding to the palm image.

2. The method according to claim 1, wherein the performing palm detection on a palm image captured by a camera to generate a palm box for a palm in the palm image comprises:
performing palm detection on the palm image to determine parameter information of the palm; and
generating the palm box for the palm in the palm image based on the parameter information of the palm,
the parameter information of the palm comprising a width, a height, and a palm box center point of the palm.

3. The method according to claim 2, wherein the determining location information of the palm relative to the camera based on the palm box and the palm image comprises:
determining orientation information of the palm relative to the camera based on the palm box center point and an image center point of the palm image.

4. The method according to claim 2, wherein the determining location information of the palm relative to the camera based on the palm box and the palm image comprises:
calculating distance information of the palm relative to the camera based on the width and/or the height of the palm box.

5. The method according to claim 4, wherein the calculating distance information of the palm relative to the camera based on the width and/or the height of the palm box comprises:
calculating an area of the palm box based on the width and the height of the palm box; and
comparing the area of the palm box with a preset area threshold to obtain the distance information of the palm relative to the camera.

6. The method according to claim 4, wherein the calculating distance information of the palm relative to the camera based on the width and/or the height of the palm box comprises:
calculating a first distance value of the palm relative to the palm image recognition device based on the width of the palm box and a first threshold,
the first threshold being a value of a preset width of the palm box.

7. The method according to claim 4, wherein the calculating distance information of the palm relative to the camera based on the width and/or the height of the palm box comprises:
calculating a second distance value of the palm relative to the palm image recognition device based on the height of the palm box and a second threshold,
the second threshold being a value of a preset height of the palm box.

8. The method according to claim 4, wherein the calculating distance information of the palm relative to the camera based on the width and/or the height of the palm box comprises:
calculating a first distance value of the palm relative to the palm image recognition device based on the width of the palm box and a first threshold;
calculating a second distance value of the palm relative to the palm image recognition device based on the height of the palm box and a second threshold; and
obtaining the distance information of the palm relative to the camera based on the first distance value and the second distance value.

9. The method according to claim 1, wherein the method further comprises:
performing image division on the palm image to obtain at least two grids;
predicting at least one palm box for each grid by using a palm box recognition model to obtain a confidence value corresponding to each predicted palm box; and
determining the palm box for the palm in the palm image based on the confidence value corresponding to the predicted palm box.

10. The method according to claim 9, wherein the method further comprises:
obtaining a sample palm image and a sample palm box corresponding to the sample palm image;
performing data processing on the sample palm image by using the palm box recognition model to obtain a predicted palm box; and
updating a model parameter of the palm box recognition model based on a difference between the predicted palm box and the sample palm box.

11. A computer device comprising a processor and a memory, the memory storing at least one computer program, and the at least one computer program being loaded and executed by the processor and causing the computer device to implement a palm image recognition method including:
performing palm detection on a palm image captured by a camera to generate a palm box for a palm in the palm image;
determining location information of the palm relative to the camera based on the palm box and the palm image; and
displaying a palm identifier corresponding to the palm based on the location information, the palm identifier being used for indicating the palm to move to a preset spatial location corresponding to the camera to obtain an object identifier corresponding to the palm image.

12. The computer device according to claim 11, wherein the performing palm detection on a palm image captured by a camera to generate a palm box for a palm in the palm image comprises:
performing palm detection on the palm image to determine parameter information of the palm; and
generating the palm box for the palm in the palm image based on the parameter information of the palm,
the parameter information of the palm comprising a width, a height, and a palm box center point of the palm.

13. The computer device according to claim 12, wherein the determining location information of the palm relative to the camera based on the palm box and the palm image comprises:
determining orientation information of the palm relative to the camera based on the palm box center point and an image center point of the palm image.

14. The computer device according to claim 12, wherein the determining location information of the palm relative to the camera based on the palm box and the palm image comprises:
calculating distance information of the palm relative to the camera based on the width and/or the height of the palm box.

15. The computer device according to claim 14, wherein the calculating distance information of the palm relative to the camera based on the width and/or the height of the palm box comprises:
calculating an area of the palm box based on the width and the height of the palm box; and
comparing the area of the palm box with a preset area threshold to obtain the distance information of the palm relative to the camera.

16. The computer device according to claim 14, wherein the calculating distance information of the palm relative to the camera based on the width and/or the height of the palm box comprises:
calculating a first distance value of the palm relative to the palm image recognition device based on the width of the palm box and a first threshold,
the first threshold being a value of a preset width of the palm box.

17. The computer device according to claim 14, wherein the calculating distance information of the palm relative to the camera based on the width and/or the height of the palm box comprises:
calculating a second distance value of the palm relative to the palm image recognition device based on the height of the palm box and a second threshold,
the second threshold being a value of a preset height of the palm box.

18. The computer device according to claim 14, wherein the calculating distance information of the palm relative to the camera based on the width and/or the height of the palm box comprises:
calculating a first distance value of the palm relative to the palm image recognition device based on the width of the palm box and a first threshold;
calculating a second distance value of the palm relative to the palm image recognition device based on the height of the palm box and a second threshold; and
obtaining the distance information of the palm relative to the camera based on the first distance value and the second distance value.

19. The computer device according to claim 11, wherein the method further comprises:
performing image division on the palm image to obtain at least two grids;
predicting at least one palm box for each grid by using a palm box recognition model to obtain a confidence value corresponding to each predicted palm box; and
determining the palm box for the palm in the palm image based on the confidence value corresponding to the predicted palm box.

20. A non-transitory computer-readable storage medium storing at least one computer program, and the at least one computer program being loaded and executed by a processor of a computer device and causing the computer device to implement a palm image recognition method including:
performing palm detection on a palm image captured by a camera to generate a palm box for a palm in the palm image;
determining location information of the palm relative to the camera based on the palm box and the palm image; and
displaying a palm identifier corresponding to the palm based on the location information, the palm identifier being used for indicating the palm to move to a preset spatial location corresponding to the camera to obtain an object identifier corresponding to the palm image.
